(19) United States
(12) Patent Application Publication
(10) Pub. No.: US 2012/0185337 A1
(43) Pub. Date: Jul. 19, 2012

(54) SYSTEM AND METHOD FOR STREAMLINING SOCIAL MEDIA MARKETING

(75) Inventors: Eran RESHEF, Caesarea (IL); Amir HIRSH, Tel-Aviv (IL)

(73) Assignee: COLLACTIVE LTD., Tel Aviv (IL)

(21) Appl. No.: 13/430,966

(22) Filed: Mar. 27, 2012

Related U.S. Application Data
(63) Continuation of application No. 12/379,018, filed on Feb. 11, 2009.
(60) Provisional application No. 61/028,283, filed on Feb. 13, 2008.

(51) Int. Cl. G06Q 30/02

(52) U.S. Cl. 705/14.66

(57) ABSTRACT

A method and system for streamlining social media marketing continuous activities are provided for finding Potential Friends (PFs) on various social media avenues, gathering information about PFs' interests and activities on an going basis, creating attractive presences (APs) on various social media sites, befriending with PFs to turn them in Actual Friends (AFs), conversing with AFs to foster the relationship with them, creating Social Campaigns (SCs) to promote Desired Items (DIs), running SCs with the help of AFs, and measuring results of SCs and overall progress.

### PRIOR APPLICATION DATA

This application claims priority and benefit from U.S. Provisional Patent Application No. 61/028,283, titled “System and Method for Streamlining Social Media Marketing”, filed on Feb. 13, 2008, which is hereby incorporated by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD

Some embodiments are directed to computer networks, and more particularly to a system and method for streamlining social media marketing using computer networks.

### BACKGROUND

Social media encompasses any digital media where its participants can influence the media itself by interacting with the media and with one another. Known examples of social media are social networks, video sharing sites, social news sites, and blogs. Recently, even newspapers have started adding social media features to their sites, such as allowing readers to determine some of the front page by voting on articles they deem important. It is expected that social media will grow and evolve rapidly in the near future.

Since its dawn, social media has joined paid media (i.e., advertisement) and earned media (i.e., PR) as a place for marketing activities. Since social media is a digital form of word of mouth, it has attracted considerable amount of attention from marketeers.

As such, social media marketing is practiced today by many companies and organizations, aiming to proactively promote and protect their brand online, as well as provide market intelligence.

Unfortunately, current social media marketing process is a manual process that yields inconsistent and unpredictable results. Marketeers do not have a predictable way to create consistent viral buzz around their brand or issue. Furthermore, the current process does not allow marketeers to fully understand their customers and online brand advocates.

There are multiple challenges facing social media marketing practitioners today that lead to these inconsistent results.

First, planning social media marketing activities requires deep understanding of multiple social sites and mastery of best practices that are hard to acquire and keep changing.

Second, tactical execution requires working with dozens of ever-changing sites and thousands of online “friends” that require interaction. It is a labor intensive, time consuming and error prone process.

Finally, measurement and quantification of social media marketing efforts is not a scalable process when done manually.

There is clearly, a need to manage, streamline and measure social media marketing activities in order to generate social media results that are more predictable, measurable and cost effective.

### SUMMARY

A method and system for streamlining social media marketing continuous activities are provided for finding Potential Friends (PFs) on various social media avenues, gathering information about PFs' interests and activities on an going basis, creating attractive presences (APs) on various social media sites, befriending with PFs to turn them in Actual Friends (AFs), conversing with AFs to foster the relationship with them, creating Social Campaigns (SCs) to promote Desired Items (DIs), running SCs with the help of AFs, and measuring results of SCs and overall progress.

Some embodiments allow for finding PFs on various social media avenues who are likely to respond positively to DIs by looking for behavioral patterns indicating positive response in the past to Similar Items (SIs) that are similar in nature to DIs or are the DIs themselves. Such patterns may include submitting, positively voting, saving, sharing or positively commenting on SIs, or befriending persons who exhibited such patterns themselves.

Some embodiments allow for gathering information about PFs' interests and activities on an ongoing basis by monitoring behavioral patterns of PFs indicating an increased interest level in Trendy Items (TIs) among PFs as a group. Such patterns may include repeated submitting, voting, saving, sharing or commenting on TIs.

Some embodiments allow for creating attractive presences (APs) on various social media sites by providing clear guidelines and assistance for initial presence creation, as well as an ongoing collection of Relevant Content (RI) that is of interest to PFs and publishing it on each presence.

Some embodiments allow for befriending with PFs to turn them in Actual Friends (AFs) by whatever means are supported by the social media avenue in which each PF is active, such as sending a friend request, adding to a blogroll or sending a message.

Some embodiments allow for conversing with AFs to foster the relationship with them by monitoring the activities of AFs and responding positively to their actions in whatever fashion is supported by the social media avenue the AF is active on, such as voting for an item an AF submitted, commenting or publishing a blog post about that item.

Some embodiments allow for creating Social Campaigns (SCs) to promote Desired Items (DIs) by providing a unified way to define an SC, including for example, what DI to promote, where to promote it and when to promote it.

Some embodiments allow for running SCs with the help of AFs by publishing DIs and sharing DIs with AFs in the appropriate format for the social media avenue they are active on, such as sending a message or sharing an item.

Some embodiments allow measuring results of SCs by monitoring the various parameters relevant to DIs, such as number of users who viewed the DI, placement in the DI's primary social media avenue or coverage the DI received in other social media avenues and outside the social media. Some embodiments allow measuring overall progress of the entire social media marketing effort, by measuring and quantifying the different aspects of the marketing process, such as the number of PFs and AFs on different social media avenues and the response rates of AFs to SCs.

Some embodiments may be used to promote a brand or issue on social media in a consistent, efficient, scalable and measurable fashion.

Some embodiments may be used to understand customers, brand advocates or badvocates (people who work against a certain issue or brand) in near real time.

Other aspects would become apparent to those skilled in the relevant art(s) in view of the teachings herein. Additional aspects of some embodiments would be apparent in view of the description that follows.

### BRIEF DESCRIPTION OF THE DRAWINGS

The foregoing and other aspects of some embodiments will become more apparent from the following description of illustrative embodiments thereof and the accompanying drawings, which illustrate, by way of example, the principles of some embodiments. In the drawings:

FIG. 1 illustrates a deployment of a social media marketing system, in accordance with some demonstrative embodiments.

FIG. 2 illustrates the components of a social media marketing system and its internal data flow, in accordance with some demonstrative embodiments;

FIG. 3 illustrates a streamlined process of social media marketing, in accordance with some demonstrative embodiments;

FIG. 4 illustrates a dashboard showing all social media activities in one console, in accordance with some demonstrative embodiments;

FIG. 5 illustrates befriending with PFs to turn them in Actual Friends (AFs) on a video sharing site, in accordance with some demonstrative embodiments;

FIG. 6 illustrates a report about current PFs' interests and activities, in accordance with some demonstrative embodiments;

FIG. 7 illustrates conversing with AFs to foster the relationship with them on a video sharing site, in accordance with some demonstrative embodiments;

FIG. 8 illustrates conversing with AFs to foster the relationship with them on the blogsphere, in accordance with some demonstrative embodiments;

FIG. 9 illustrates selecting content in order to create an attractive presence (AP), in accordance with some demonstrative embodiments;

FIG. 10 illustrates creating a Social Campaign (SC) to promote a video as a DI, in accordance with some demonstrative embodiments;

FIG. 11a illustrates running an SC from the management console, in accordance with some demonstrative embodiments;

FIG. 11b illustrates the impact of said SC on the blogsphere, in accordance with some demonstrative embodiments;

FIG. 11c illustrates the reach of said SC to an AF, in accordance with some demonstrative embodiments;

FIG. 12 illustrates measuring results of an SC, in accordance with some demonstrative embodiments.

### DETAILED DESCRIPTION

Some embodiments will now be described in detail with reference to the drawings, which are provided as illustrative examples of some embodiments so as to enable those skilled in the relevant art(s) to practice some embodiments. Notably, the figures and examples below are not meant to limit the scope to a single embodiment, but other embodiments are possible by way of interchange of some or all of the described or illustrated elements. Moreover, where certain elements of some embodiments can be partially or fully implemented using known components, only those portions of such known components that are necessary for an understanding of some embodiments will be described, and detailed descriptions of other portions of such known components will be omitted so as not to obscure the description. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, some embodiments encompass present and future known equivalents to the known components referred to herein by way of illustration.

### Overview of a Social Media Marketing System

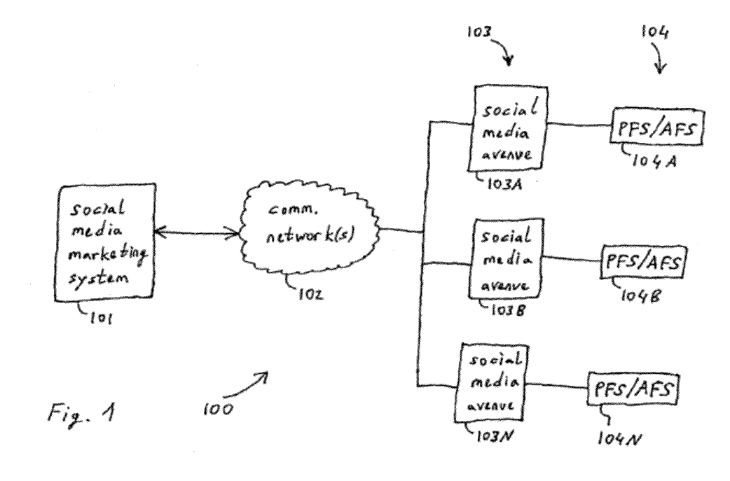

FIG. 1 illustrates a deployment of a social media marketing system 100 that includes the social media marketing system itself 101, a plurality of social media avenues 103a-103n, each hosting Potential Friends (PFs) and Actual Friends (AFs) 104a-104n, and a communications network 102. The deployment of a social media marketing system 100 provides for streamlining social media marketing continuous activities as described in greater details below.

A social media marketing system 101 uses communications network 102 to communicate with a plurality of social media avenues 103a-103n in order to receive or transmit information as described in more details later. Said information may be received or transmitted by social media avenues 103a-103n to Potential Friends (PFs) and Actual Friends (AFs) 104a-104n. A social media marketing system 101 may also communicate directly with Potential Friends (PFs) and Actual Friends (AFs) 104a-104n.

A social media marketing system 101 can be implemented via one or more servers, with each server being one or more computers providing various shared resources with each other and to other system components. The shared resources include files for programs, web pages, databases and libraries; output devices, such as, printers, plotters, display monitors and facsimile machines; communications devices, such as modems and Internet access facilities; and other peripherals such as scanners, or the like. The communications devices can support wired or wireless communications, including satellite, terrestrial (fiber optic, copper, coaxial, and the like), radio, microwave, free-space optics, and/or any other form or method of transmission.

The server hosting a social media marketing system 101 can be configured to support the standard Internet Protocol (IP) developed to govern communications over public and private Internet backbones. The protocol is defined in Internet Standard (STD) 5, Request for Comments (RFC) 791 (Internet Architecture Board). The server also supports transport protocols, such as, Transmission Control Protocol (TCP), User Datagram Protocol (UDP), Real Time Transport Protocol (RTP), or Resource Reservation Protocol (RSVP). The transport protocols support various types of data transmission standards, such as File Transfer Protocol (FTP), Hypertext Transfer Protocol (HTTP), Simple Network Management Protocol (SNMP), Network Time Protocol (NTP), or the like.

Communications network 102 provides a transmission medium for communicating among the system components. Communications network 102 includes a wired and/or wireless local area network (LAN), wide area network (WAN), or metropolitan area network (MAN), such as an organization's intranet, a local Internet, the global-based Internet (including the World Wide Web (WWW)), an extranet, a virtual private network, licensed wireless telecommunications spectrum for digital cell (including CDMA, TDMA, GSM, EDGE, GPRS, CDMA2000, WCDMA FDD and/or TDD or TD-SCDMA technologies), or the like. Communications network 110 includes wired, wireless, or both transmission media, including satellite, terrestrial (e.g., fiber optic, copper, UTP, STP, coaxial, hybrid fiber-coaxial (HFC), or the like), radio, free-space optics, microwave, and/or any other form or method of transmission.

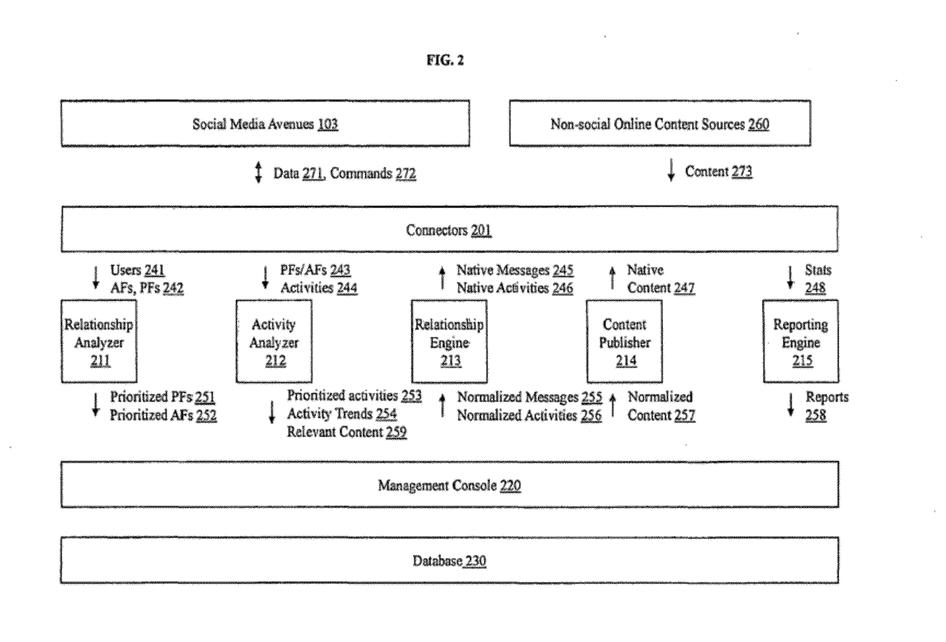

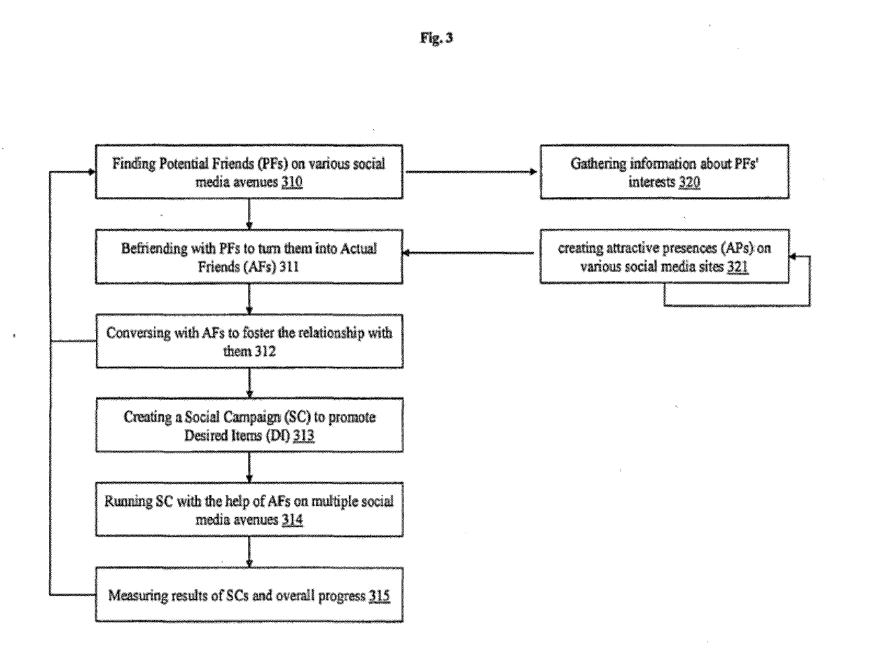

FIG. 3. illustrates a streamlined process of social media marketing conducted by using a social media marketing system 101, whose internal data flow is illustrated in FIG. 2.

Finding Potential Friends (PFs) on various social media avenues 310 is done by the Relationship Analyzer 211 that analyzes users 241 and outputs a Prioritized PFs 251. This analysis is done, for example, by finding the subset of users 241 who are likely to respond positively to DIs by looking for behavioral patterns indicating positive response in the past to Similar Items (SIs) that are similar in nature to DIs or are the DIs themselves. Such patterns may include submitting, positively voting, saving, sharing or positively commenting on SIs, or befriending persons who exhibited such patterns themselves. Other examples of analysis include comparing the details of users 241 to known details of AFs on other social media avenues, such as nickname, and finding the matching subset.

Befriending with PFs to turn them into Actual Friends (AFs) 311 is done from the management console 220 by selecting the PFs of interest. The Relationship Engine 213 translates the normalized message 255 of befriending, which looks the same across all social media avenues 103, to the native message 245 of befriending, which is different in each social media avenue 103a-103n (e.g., sending a friend request, adding to a blogroll or sending a message).

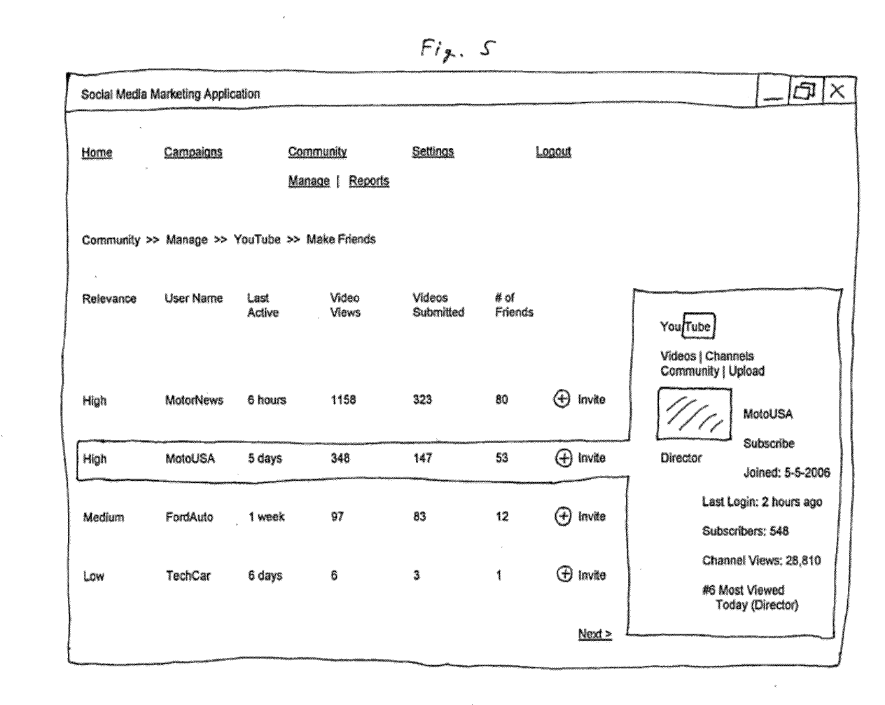

FIG. 5 illustrates a screen of a management console 220 for displaying a list of PEs found by the Relationship Analyzer 211 on a video sharing site and providing an interface for befriending with said PEs using the Relationship Engine 213. The PEs are ranked according to their likelihood to become active AFs who will participate in future Social Campaigns (SCs).

Gathering information about PFs' interests and activities on an ongoing basis 320 is a parallel process to befriending PFs 311. Gathering 320 is done by the Activity Analyzer 212 by monitoring behavioral patterns of PFs indicating an increased interest level in Trendy Items (TIs) among PFs as a group. Such patterns may include repeated submitting, voting, saving, sharing or commenting on TIs. The Activity Analyzer 212 outputs Activity Trends 254 to Management Console 220.

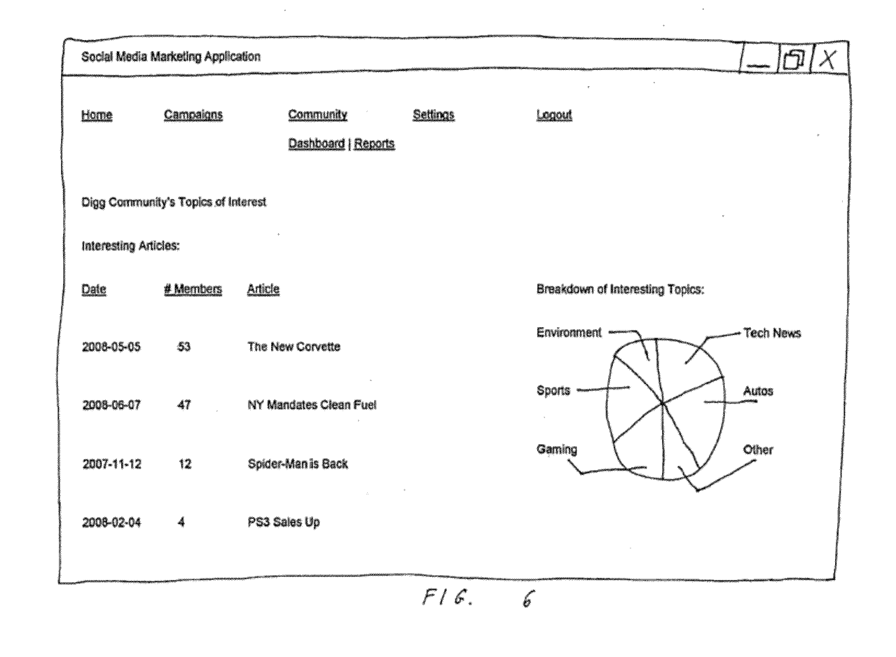

FIG. 6 illustrates a screen of a management console 220 for displaying a list of TIs gathered from PFs on a social news site.

Creating attractive presences (APs) on various social media sites 321 is also done in parallel to befriending to increase the chances of successful befriending. This is done by providing clear guidelines and assistance for initial presence creation, as well as an ongoing collection of Relevant Content 259 that is of interest to PFs and publishing it on each presence. Relevant Content 259 is found by the Activity Analyzer 212 by combining content highlighted by Activity Trends 254 and Content 273 collected from Non-social Online Content Sources 260 (e.g., newspapers) by performing keyword searches and similar automated queries. Relevant Content 259 is displayed on management console 220, and content selected is published by the Content Publisher 214. The Content Publisher 214 translates the normalized content 257, which looks the same across all social media avenues 103, to the native content 247, which is different in each social media avenue 103a-103n.

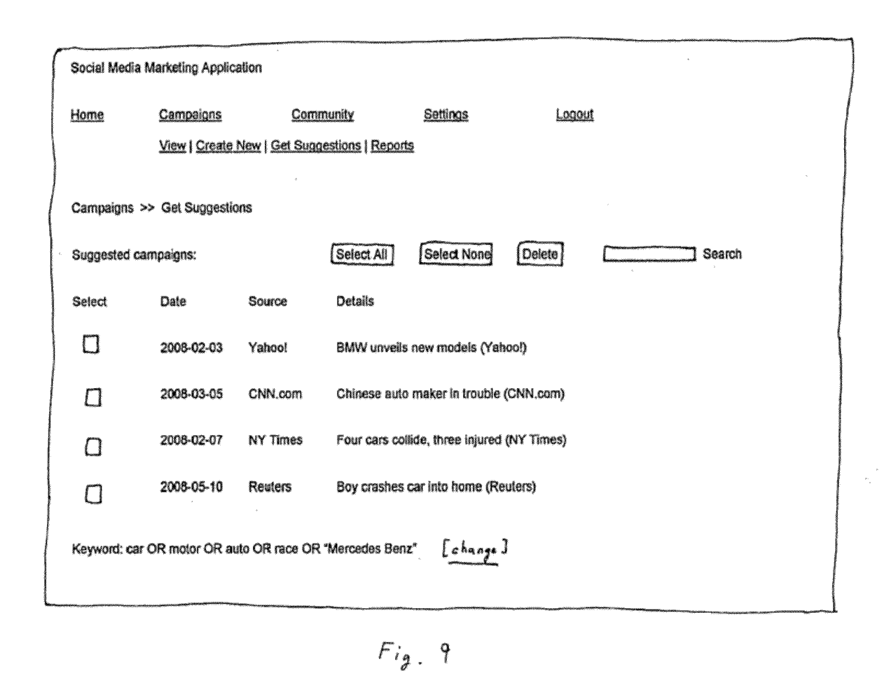

FIG. 9 illustrates a screen of a management console 220 for displaying Relevant Content 259.

Conversing with AFs to foster the relationship with them 312 is done from the management console 220. The Activity Analyzer 212 monitors activities 244 and by using the Prioritized AFs 252 outputs a prioritized activity list 253 that, for example, ranks higher activities of AFs who participated in past SCs, or lower AFs whose recent past activities received a response from the social media marketing system 101. Using management console 220 a positive, normalized activity 256 responding to AFs' actions 253 is generated (e.g. voting for an item an AF submitted, commenting or publishing a blog post about that item). The Relationship Engine 213 translates the normalized activity 256, which looks the same across all social media avenues 103, to the native activity 246, which is different in each social media avenue 103a-103n

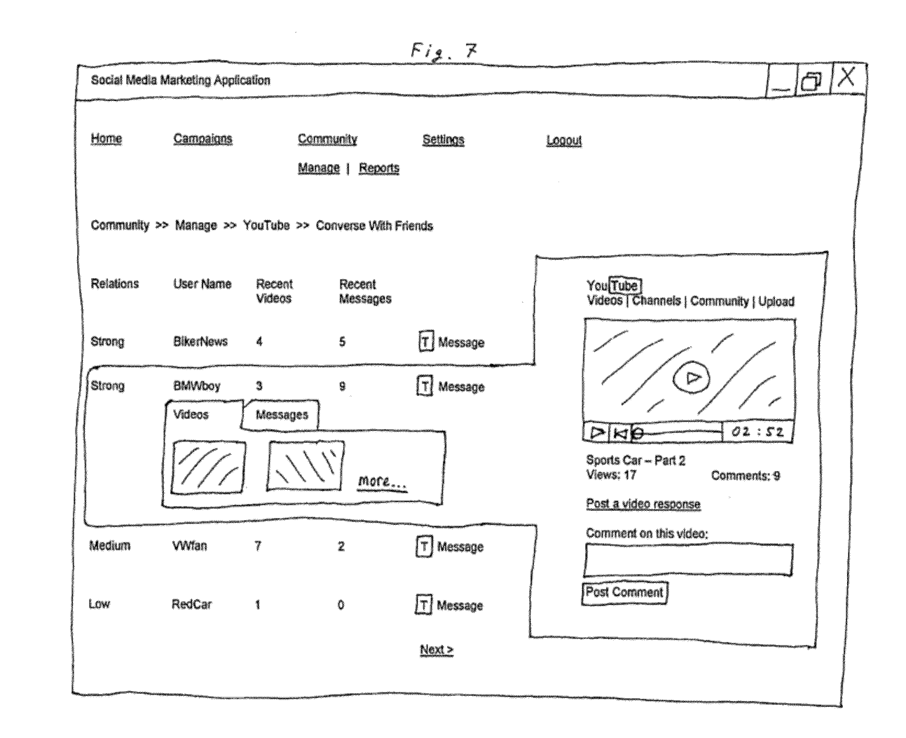

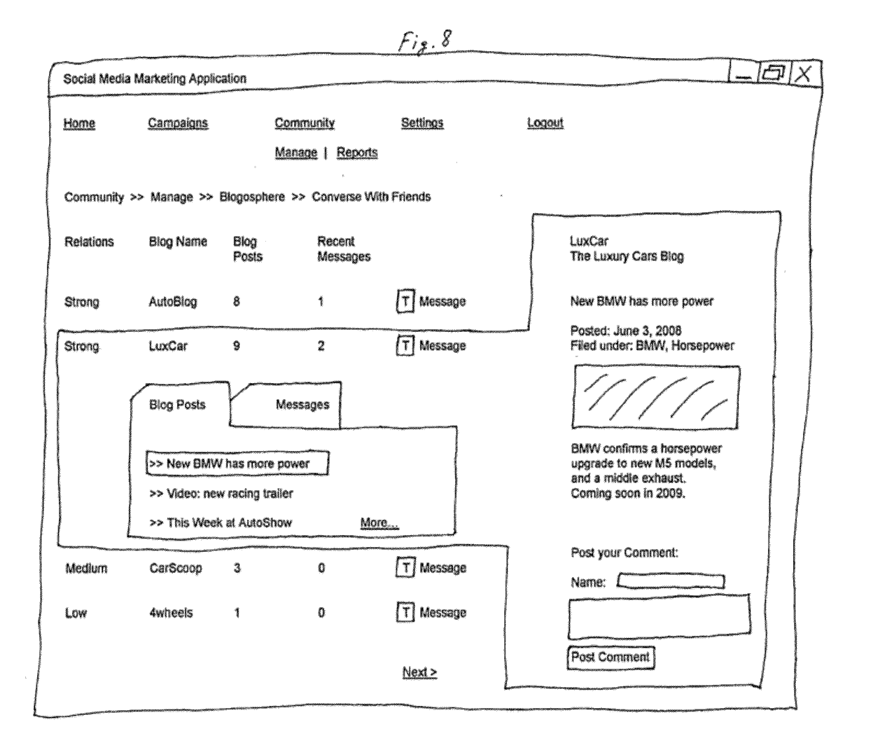

FIG. 7. illustrates a screen of a management console 220 for displaying and responding to prioritized activity list 253 on a video sharing site. FIG. 8 illustrates a similar function for the blogosphere.

Creating a Social Campaign (SC) to promote Desired Items (DI) 313 is done from the management console 220 that provides a unified way to define an SC, including for example, what DI to promote, where to promote it and when to promote it.

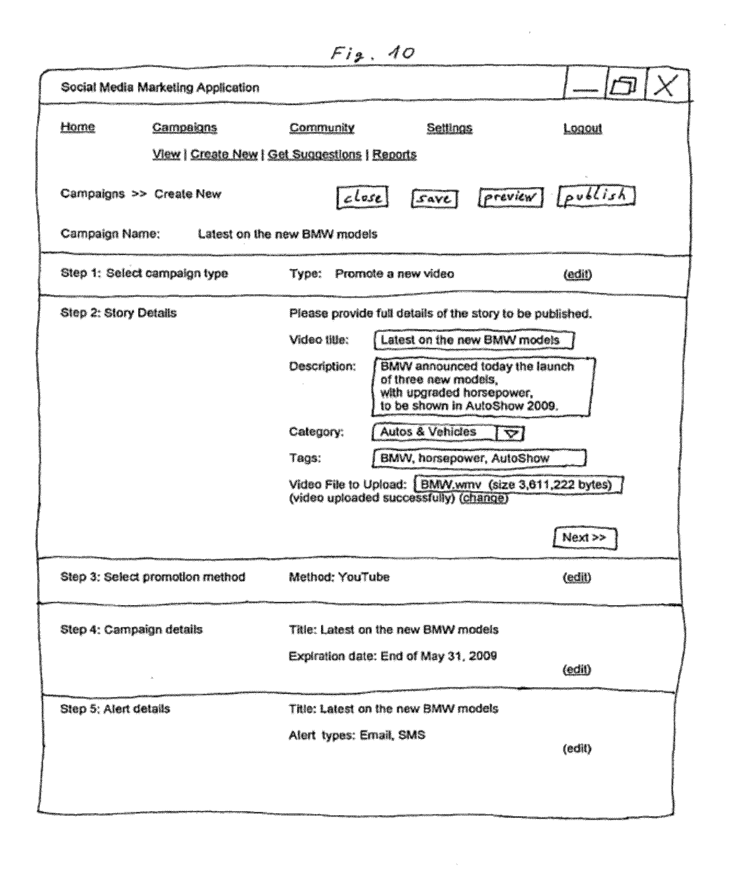

FIG. 10 illustrates a screen of a management console 220 for defining an SC for promoting a video.

Running SC with the help of AFs on multiple social media avenues 314 is done from the management console 220 by the Content Publisher 214 and Relationship Engine 213.

If needed, The Content Publisher 214 translates and publishes the DI referred to by said SC (Normalized Content 257), which looks the same across all social media avenues 103, to the native content 247, which may be different in each social media avenue 103a-103n.

The Relationship Engine 213 translates the normalized messages 255 to AFs about the DI to the native messages 245, which may be different in each social media avenue 103a-103n, such as sending a message about the DI or sharing the DI.

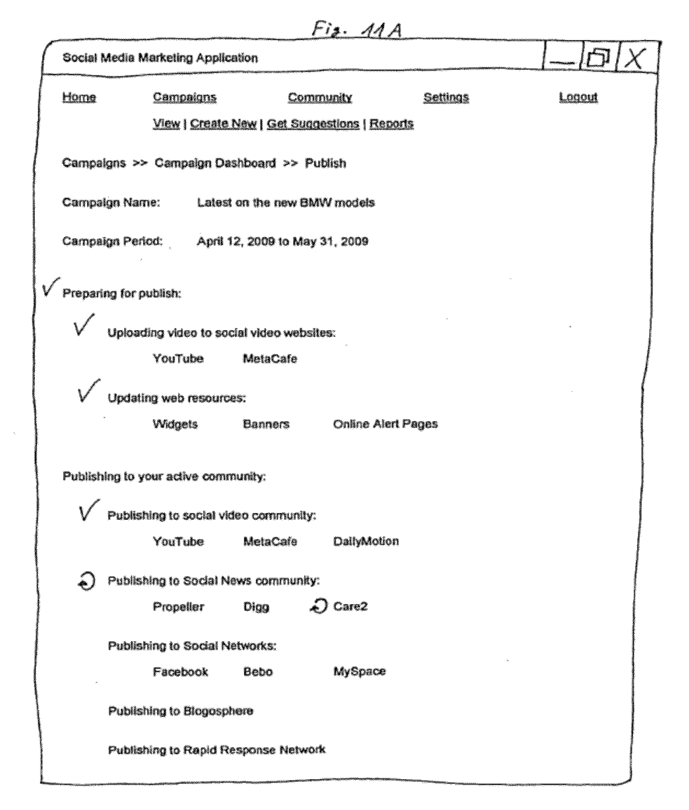

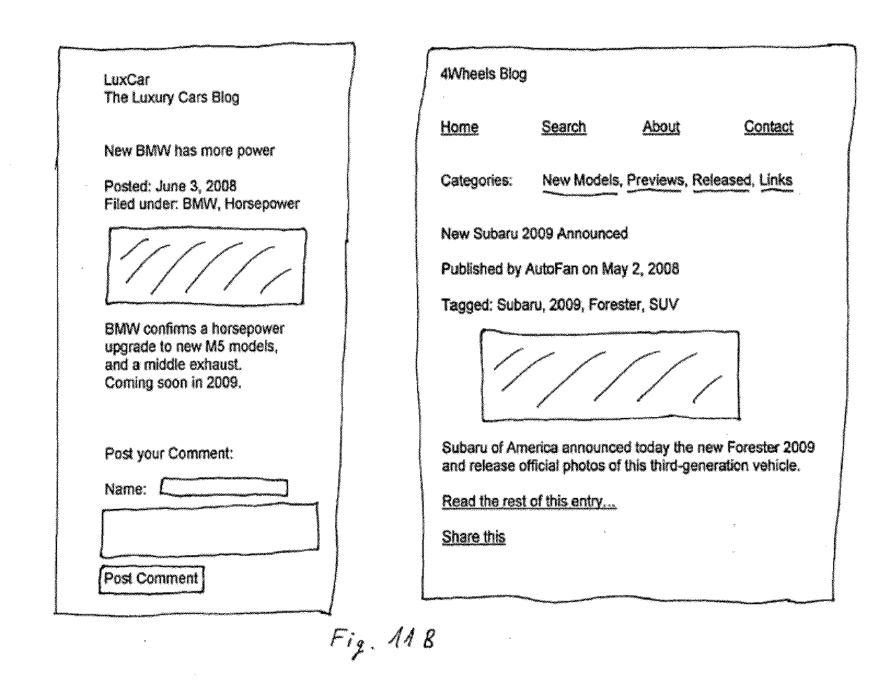

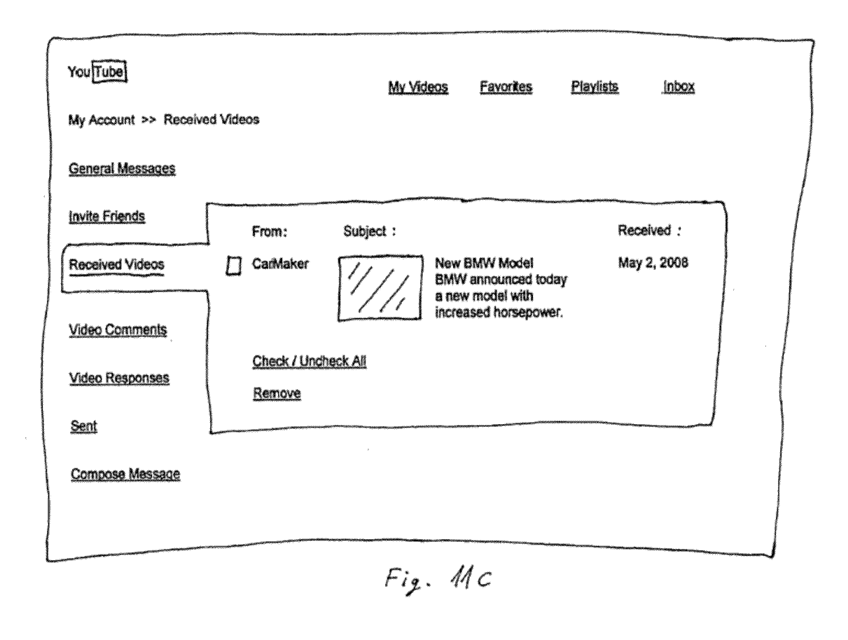

FIG. 11a illustrates a screen of a management console 220 showing the publishing process of video DI to several video sharing sites and sharing the video DI with AFs on multiple social media avenues.

FIG. 11b illustrates a blog item written by an AF who is a blogger in response to a message about a video DI, as well as a blog of another blogger AF showing a widget that was automatically updated to display the video DI published.

FIG. 11c illustrates a message sent to an AF who is a friend on a video sharing site about the video DI.

Measuring results of SCs and overall progress 315 is done by the Reporting Engine 215 by reading stats 248 about items of interests, such as DIs and AFs, and creating reports 258.

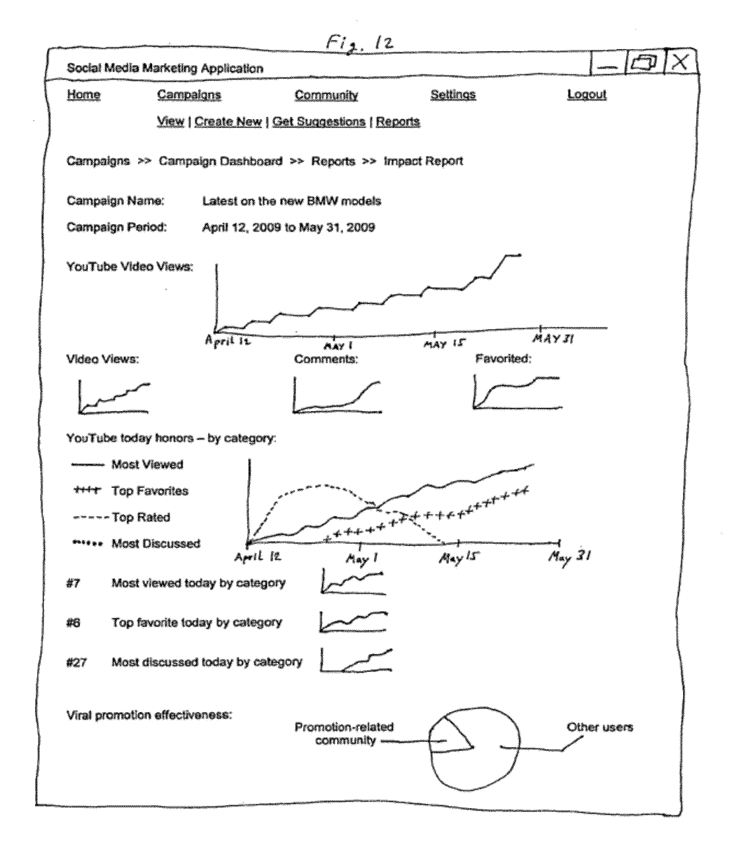

FIG. 12 illustrates a screen of a management console 220 showing a report about the progress of an SC promoting a video DI.

Database 230 is used to store all relevant information from the different components of the Social Media Marketing System 101.

Connectors 201 are used to pass Data 271 and Commands 272 from the Social Media Marketing System 101 to the different in each social media avenue 103a-103n.

System 100 can be used to promote a brand or issue on social media in a consistent, efficient, scalable and measurable fashion. System 100 can also be used to understand customers, brand advocates or badvocates in near real time.

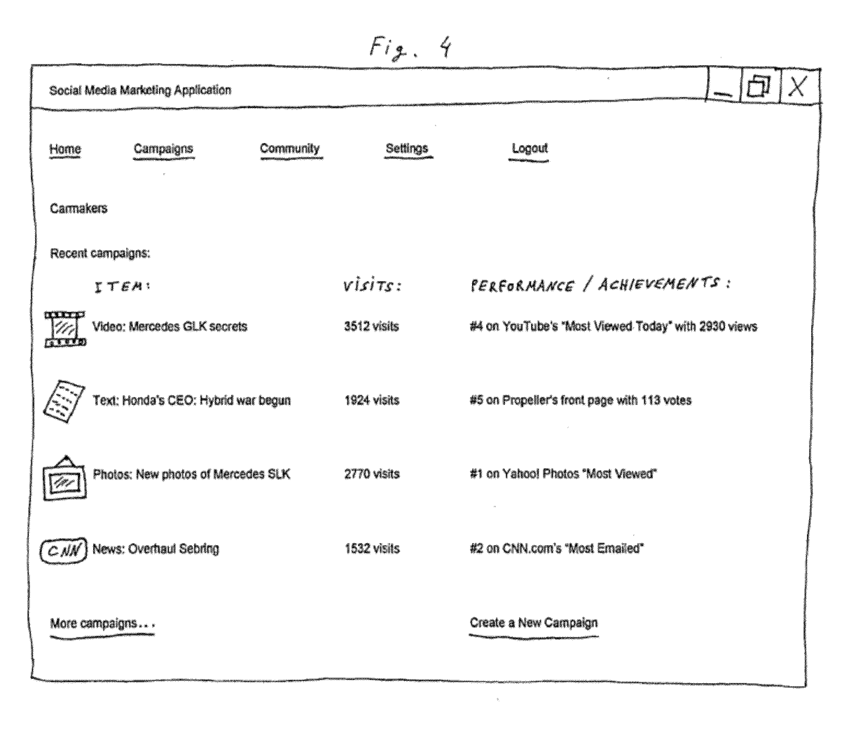

Other business models and technical aspects would become apparent to those skilled in the relevant art(s) in view of the teachings herein. FIGS. 1-12 are conceptual illustrations allowing an explanation of some embodiments. It should be understood that various aspects of some embodiments could be implemented in hardware, firmware, software, or a combination thereof. In such an embodiment, the various components and/or steps would be implemented in hardware, firmware, and/or software to perform the functions of some embodiments. That is, the same piece of hardware, firmware, or module of software could perform one or more of the illustrated blocks (i.e., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by a processor to cause the processor to perform the functions of some embodiments as described herein. In this document, the tetras “machine readable medium,” “computer program medium” and “computer usable medium” are used to generally refer to media such as a removable storage unit (e.g., a magnetic or optical disc, flash ROM, or the like), a hard disk, signals (i.e., electronic, electromagnetic, or optical signals), or the like.

The term “plurality” as used herein includes “two or more”.

The terms “comprising” or “comprises” as used herein include “including at least” or “including, but not limited to”.

Some embodiments may be implemented using a computerized system or platform including, for example, processors able to execute instructions and/or process data, short term memory units, long term storage units, input units (e.g., keyboard, mouse), output units (e.g., display units, monitors, screens, speakers), communication units (e.g., modem, Network Interface Cards (NICs), network adaptors, wired or wireless transceivers), Operating Systems, applications, and/or other suitable components. Some embodiments may utilize client-server architecture, distributed architecture, centralized architecture, peer-to-peer architecture, Web-based architecture, or the like.

The foregoing description of the specific embodiments will so fully reveal the general nature of some embodiments that others can, by applying knowledge within the skill of the relevant art(s) (including the contents of the documents cited and incorporated by reference herein), readily modify and/or adapt for various applications such specific embodiments, without undue experimentation, without departing from the general concept. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the art.

While various embodiments have been described above, it should be understood that they have been presented by way of example, and not limitation. It would be apparent to one skilled in the relevant art(s) that various changes in form and detail could be made therein without departing from the spirit and scope of some embodiments. Thus, some embodiments should not be limited by any of the above-described exemplary embodiments, but should be defined only in accordance with the following claims and their equivalents.

1-21. (canceled)

22. A method for streamlining social media marketing, the method comprising:
automatically monitoring, by an activity analyzer module, social media activities of actual friends of a user on one or more social media networks;
automatically generating, by said activity analyzer module, a prioritized activity list which ranks higher social media activities performed by actual friends that participated in past social media campaigns;
automatically displaying to said user, through a computerized interface, said prioritized activity list;
automatically generating a positive social media activity which responds to at least one of the social media activities of said prioritized activity list,
wherein the method is to be performed by a computerized platform which comprises at least a hardware component.

23. The method of claim 22, comprising:
automatically generating a positive social media activity towards a subset of users of said one or more social networks who are likely to perform a positive response to a desired item associated with said user.

24. The method of claim 23, comprising:
determining said subset of users based on behavioral patterns indicating positive response to at least one social media item which is similar to said desired item.

25. The method of claim 23, wherein generating the positive social media activity comprises at least one of:
submission of an item which is similar to said desired item;
submission of a positive vote for an item which is similar to said desired item;
saving an item which is similar to said desired item;
sharing with another user an item which is similar to said desired item;
submitting a positive comment on an item which is similar to said desired item;
befriending another user who provided positive response to said desired item.

26. The method of claim 22, comprising:
continuously monitoring online activities of one or more users on said social media networks; and
automatically befriending said one or more users thorough said social media networks.

27. The method of claim 22, comprising:
identifying a behavioral pattern of one or more users indicating an increased interest in a trendy item among said one or more users as a group.

28. The method of claim 22, further comprising:
automatically creating on one or more digital social media avenues one or more attractive presences to generate positive reputation on said one or more digital social media avenues.

29. The method of claim 28, wherein automatically creating comprises:
continuously collecting relevant content of interest to said one or more users; and
automatically publishing said relevant content on each one of said attractive presences.

30. The method of claim 23, comprising;
receiving a normalized version of said desired item;
generating a native version of said desired item corresponding to a particular digital social media; and
publishing said native version through said particular digital social media.

31. The method of claim 22, comprising:
automatically performing an online activity, which is native to said digital social media, and which fosters long-term online relationship with one or more users of said one or more social media networks.

32. The method of claim 23, further comprising:
determining results of a social campaign to promote said desired item, wherein the social campaign comprises publishing said desired item to said one or more users of said digital social media.

33. The method of claim 32, wherein determining the results of the social campaign comprises:
determining the results based on at least one of:
a number of users who received the desired item;
a number of users who viewed the desired item;
a number of users who responded to the desired item; and
a number of users who responded positively to the desired item.

34. The method of claim 12, wherein determining the results of the social campaign comprises:
determining the results based on at least one of:
placement of the desired item in a primary avenue of said digital social media;
coverage of the desired item in an avenue of said digital social media; and
coverage of the desired item externally to the digital social media.

35. The method of claim 23, further comprising:
creating a social campaign by defining said desired item to be promoted, where to promote said desired item, and when to promote said desired item.

36. The method of claim 22, further comprising:
automatically measuring overall progress of social media marketing efforts.

37. The method of claim 22, further comprising:
monitoring online interactions among online friends; and
based on the monitoring, determining an interest of one or more of said online friends.

38. The method of claim 23, further comprising:
monitoring a total number of actual friends and respective response rate of said actual friends to said at least one desired item.

39. The method of claim 22, wherein generating the prioritized activity list comprises:
automatically generating, by said activity analyzer module, said prioritized activity list which ranks lower social media activities performed by actual friends that already received a response from said user for a recent social media activity.

40. A system for streamlining social media marketing, the system comprising:
a computerized platform
to automatically monitor social media activities of actual friends of a user on one or more social media networks,
to automatically generate a prioritized activity list which ranks higher social media activities performed by actual friends that participated in past social media campaigns,
to automatically display to said user, through a computerized interface, said prioritized activity list, and
to automatically generate a positive social media activity which responds to at least one of the social media activities of said prioritized activity list.

41. The system of claim 40, wherein the computerized platform is to automatically generate a positive social media activity towards a subset of users of said one or more social networks who are likely to perform a positive response to a desired item associated with said user.

42. The system of claim 41, wherein the positive response comprises at least one of:
submission of an item which is similar to said desired item;
submission of a positive vote for an item which is similar to said desired item;
saving an item which is similar to said desired item;
sharing with another user an item which is similar to said desired item;
submitting a positive comment on an item which is similar to said desired item;
befriending another user who provided positive response to said desired item.
